(19) United States
(12) Patent Application Publication
(10) Pub. No.: US 2025/0369817 A1
(43) Pub. Date: Dec. 4, 2025

(54) PRESSURE INFORMATION REPORTING APPARATUS FOR FIRE EXTINGUISHER

(71) Applicant: NISSIM ASULIN, SHOHAM (IL)

(72) Inventor: NISSIM ASULIN, SHOHAM (IL)

(21) Appl. No.: 19/211,196

(22) Filed: May 18, 2025

(30) Foreign Application Priority Data
Jun. 2, 2024 (IL) 313251

(51) Int. Cl. G01L 19/08; A62C 13/76

(52) U.S. Cl. CPC G01L 19/086; A62C 13/76; G01L 19/083

(57) ABSTRACT

A pressure information reporting apparatus for being assembled to a fire extinguisher, the pressure information reporting apparatus including a convertor, for converting pressure measurement of the fire extinguisher to electronic information, and a transmitter, for transmitting the electronic information.

### CROSS-REFERENCE TO RELATED APPLICATIONS

This application claims the benefit of priority from Israel Patent Application No. 313251, filed Jun. 2, 2024, the disclosure of which is incorporated herein by reference.

### TECHNICAL FIELD

The invention relates to the field of fire extinguishers.

### BACKGROUND

FIG. 1 depicts a prior art fire extinguisher

Today, in order to make sure that fire extinguishers will be in good condition and meet the standard today, an annual auditor goes through six fire extinguisher locations and checks that the extinguishers are in good condition.

Getting to the place where the fire extinguishers are located is complex and expensive. Today, they look for where the fire extinguishers are and then check them. A one-year inspection of fire extinguishers does not give quality test results, because during the year between inspections, various events can occur with the fire extinguisher, for example slow leakage of the extinguishing agent, pressure drop, partial or complete discharge initiated by the users.

Fire extinguishers become obsolete over time and their efficiency is compromised. Annual and regular periodic inspection by a professional control team is required.

However, mechanical pressure meter 18 is analog, thus reading whether the measured pressure, is sufficient is viewable by the eye only.

There is a long felt need to provide a solution to the above-mentioned and other problems of the prior art.

### SUMMARY

A pressure information reporting apparatus including:
a convertor, for converting pressure measurement of the fire extinguisher to electronic information; and
a transmitter for transmitting the electronic information.

### BRIEF DESCRIPTION OF THE DRAWINGS

Embodiments, features, and aspects of the invention are described herein in conjunction with the following drawings in which:

FIG. 1 depicts a prior art fire extinguisher;

FIG. 2 depicts the step of preparing for assembling the pressure information reporting apparatus according to one embodiment of the invention to the prior art pressure meter of FIG. 1;

FIG. 3 depicts the pressure information reporting apparatus according to one embodiment of the invention, and the position prior to assembling thereof to the prior art pressure information reporting apparatus of FIG. 1;

FIG. 4 depicts the mechanical unit of FIG. 3 assembled to the prior art pressure information reporting apparatus of FIG. 1;

FIG. 5 is a mechanical and electrical block diagram of the mechanical unit of FIG. 3 assembled to the prior art pressure information reporting apparatus of FIG. 1;

FIG. 6 depicts a convertor according to another embodiment; and

FIG. 7 depicts the fire extinguisher of FIG. 1 including the features of the information reporting apparatus of FIG. 3.

The drawings are not necessarily drawn to scale.

### DETAILED DESCRIPTION

The invention will be understood from the following detailed description of embodiments of the invention, which are meant to be descriptive and not limiting. For the sake of brevity, some well-known features are not described in detail.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

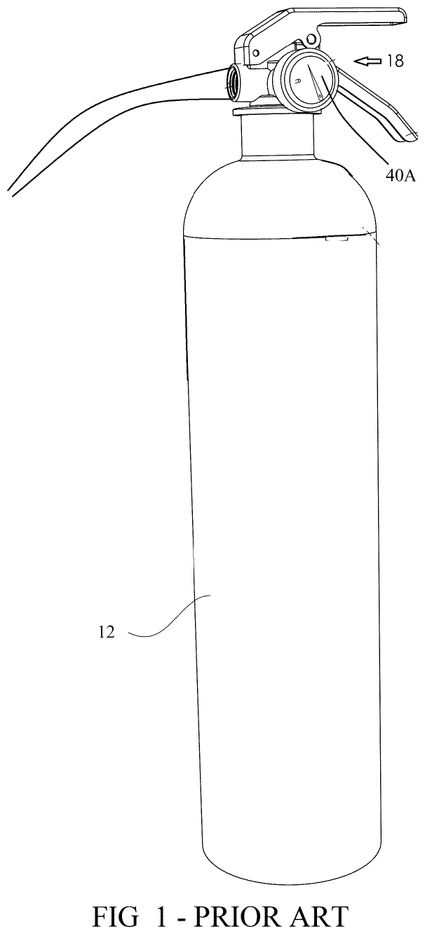

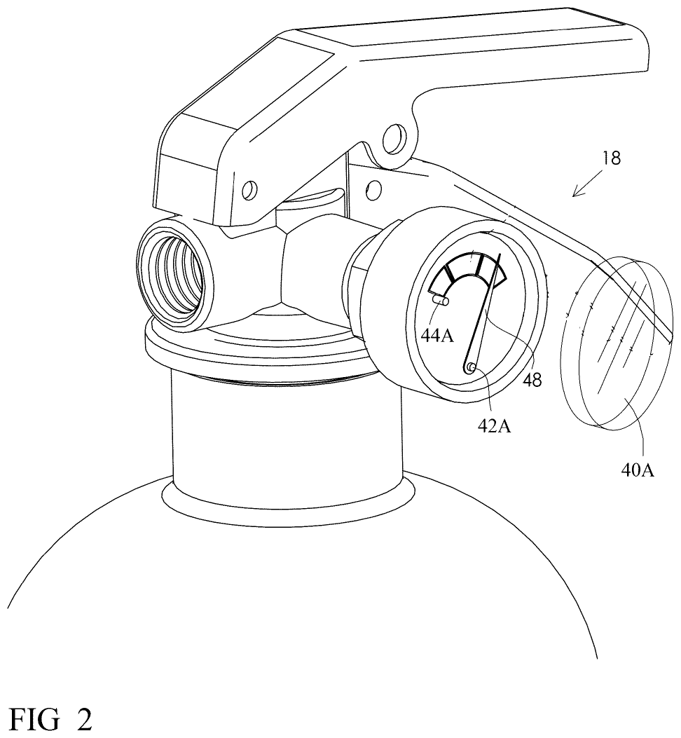

FIG. 2 depicts the step of preparing for assembling the pressure information reporting apparatus according to one embodiment of the invention to the prior art pressure meter of FIG. 1.

At the first step, the transparent plate 40A is removed from mechanical pressure meter 18.

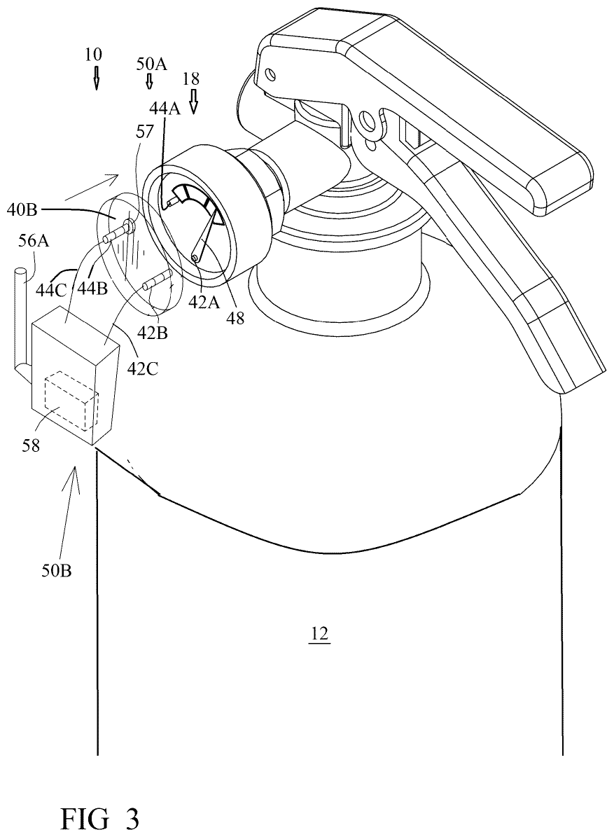

FIG. 3 depicts the pressure information reporting apparatus according to one embodiment of the invention, and the position prior to assembling thereof to the prior art pressure information reporting apparatus of FIG. 1.

An information reporting apparatus 10 according to one embodiment, includes a transparent plate 40B, shaped similar to transparent plate 40A, for being assembled to mechanical pressure meter 18; an electricity conducting pin 42B extending from transparent plate 40B, located for meeting the hinge 42A of hand 48 of mechanical pressure meter 18; an electric wire 42C, extending from pin 42B outside, such as through transparent plate 40B; an electricity conducting pin 44B extending from transparent plate 40B, located for meeting the blocker 44B of hand 48 of mechanical pressure meter 18; an electric wire 44C, extending from pin 44B outside, such as through transparent plate 40B; and an electronic unit 50B connected to electric wires 42C and 44C.

Transparent plate 50B together with pins 42B and 44B are referred herein as the mechanical unit 50A of pressure information reporting apparatus 10.

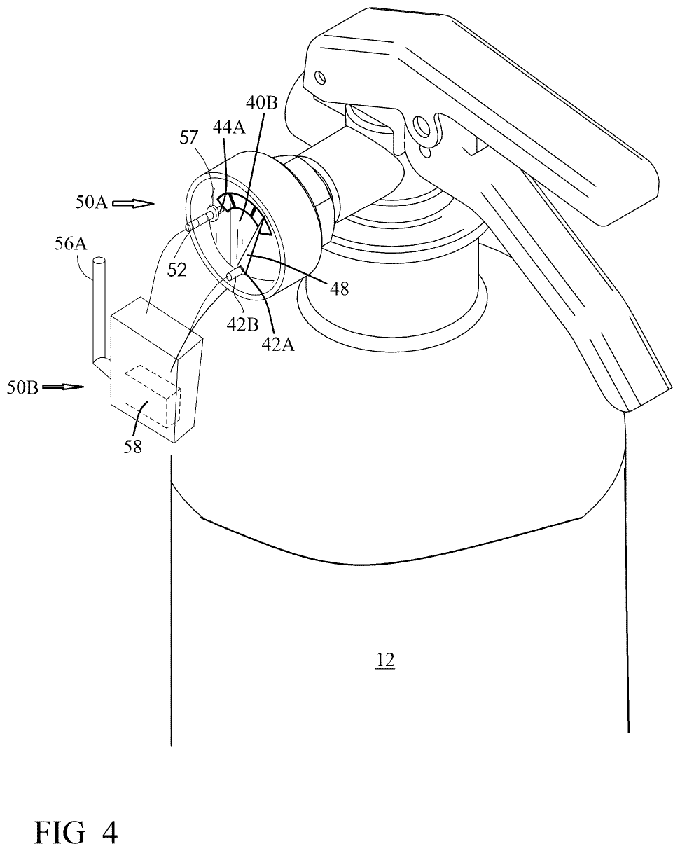

FIG. 4 depicts the mechanical unit of FIG. 3 assembled to the prior art pressure information reporting apparatus of FIG. 1.

Assembling of mechanical unit 50A to mechanical pressure meter 18, attaches pin 42B of mechanical unit 50A to hinge 42A of mechanical pressure meter 18; and attaches pin 44B of mechanical unit 50A to zero-pressure blocker 44A of mechanical pressure meter 18. Thus, in case of no pressure, in which hand 48 touches zero pressure blocker 44A, pins 42B and 44B of mechanical unit 50A connect one another electronically.

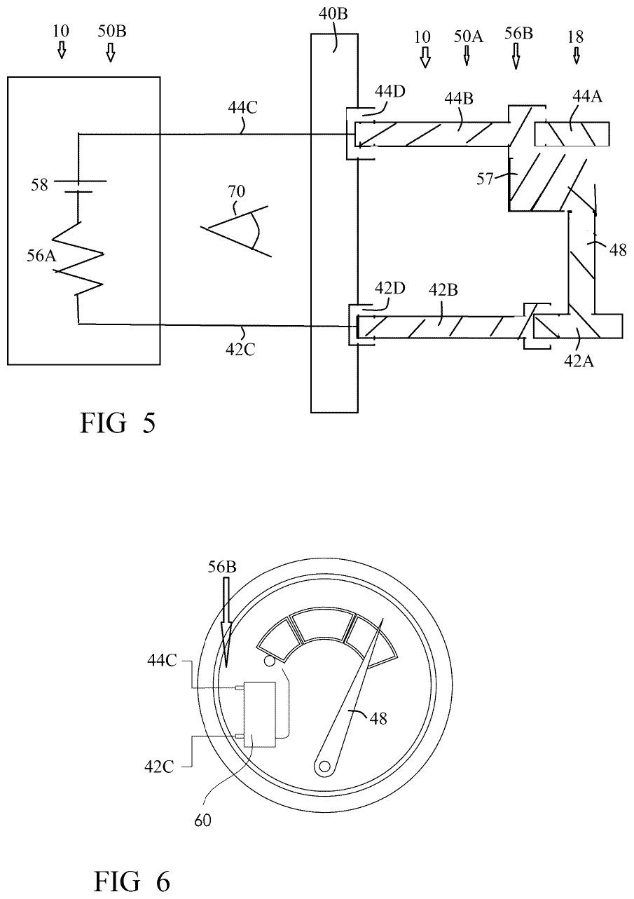

FIG. 5 is a mechanical and electrical block diagram of the mechanical unit of FIG. 3 assembled to the prior art pressure information reporting apparatus of FIG. 1.

Pin 44B of mechanical unit 50A may include a mechanical extension 57, for providing that even in case of pressure above zero pressure, hand 48 will touch extension 57 of pin 44B, for electrically connecting pins 42B and 44B to one another.

Transparent plate 40B may include a niche 44D for holding the end of pin 44B and for threading the end of wire 44C therethrough; and a niche 42D for holding the end of pin 42B and for threading the end of wire 42C therethrough.

Electrical connection of pins 42B and 44B to one another through hand 48 closes a circuit including electrical wires 42C and 44C and battery 58 and transmitter 56A, for reporting the pressure is low.

Thus, pins 42B and 44B form a convertor 56B for converting the position of hand 48 to electronic information.

FIG. 6 depicts a convertor according to another embodiment.

Convertor 56B may constitute a micro-switch 60 including an arm disposed near hand 48 for being pressed by hand 48 for closing the electric circuit once hand 48 indicates low pressure.

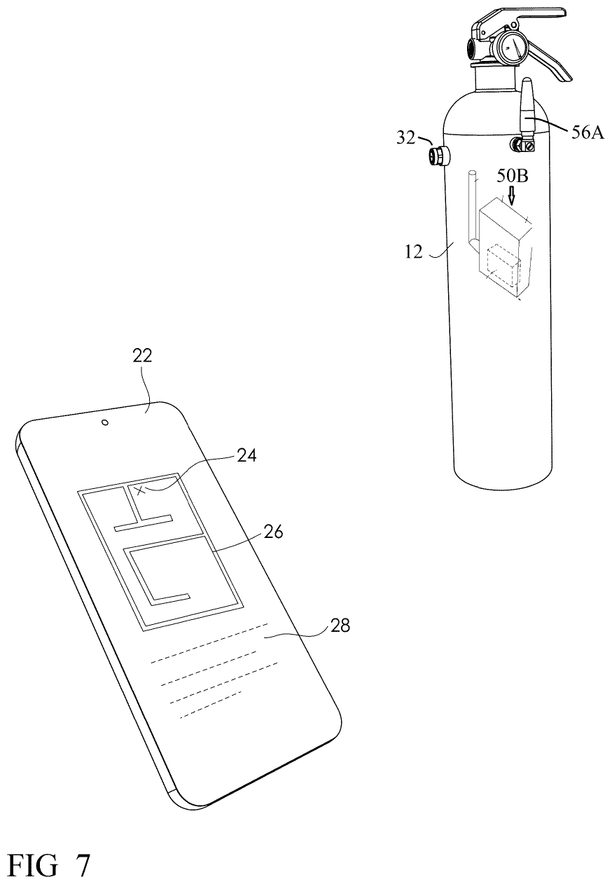

FIG. 7 depicts the fire extinguisher of FIG. 1 including the features of the information reporting apparatus of FIG. 3.

Electronic unit 50B including transmitter 56A may further communicate with a smartphone 22, for guiding the user of smartphone 22 to find fire extinguisher 12, and to read information from additional sensors, such as humidity sensor 32.

The present invention refers to a system for testing fire extinguishers that contains a parallel connection of a controller that contains, for example, a pressure sensor, a location sensor, for example, a GPS, a temperature sensor, and a flame sensor, a humidity sensor, a gas pressure sensor, etc. and during an event that causes one or more sensors to detect a safety phenomenon, the controller will transmit by, for example, a communication system Lora” GSM, etc. to the application “Ladmin” for a mobile phone, to a PC center, etc. For example, as soon as the gas pressure in the fire extinguisher drops below the set limit, the fire extinguisher will transmit a distress signal that will contain the address where the fire extinguisher is located and its location in the address and will allow the inspector to reach the malfunctioning fire extinguishers.

Even in the annual inspection that will be conducted, the inspector can reach for example the faulty fire extinguishers from which alerts were received. The cooler will contain an algorithm that will count the number of presses on the fire extinguisher handle, the time of each press and the amount of extinguishing agent that came out of the fire extinguisher tank. The information will be stored in a controller, for example an Arduino, which will transmit the above information in real time to the fire extinguisher, including the number of the fire extinguisher, the owner of the fire extinguisher, including the address and its location, so that the system can give a higher resolution of the fire extinguisher's status, for example, a fire extinguisher that contains 100% fire extinguisher, a fire extinguisher that contains 98%, 80% 70% etc.

The system is in sleep mode and wakes up only when there is an event, for example, a pressure lock, extinguishing agent, etc., thus saving battery life and can operate for a relatively long time.

The system can, for example, call the rescue forces during an event, for example a fire, etc. and an exact location will be sent.

The system for testing fire extinguishers can also be adapted to a system for extinguishing systems in vehicles, combat vehicles, airplanes, etc.

According to the present invention, the invention is also suitable for buses, trucks or any land or sea means of transport, including air.

According to another preferred configuration, weight can also be checked by a weight sensor in addition to the other additional measurements, by including a weighing meter that checks the amount of powder, because according to regulation, that's how they check, thus the apparatus checks the weight of the powder.

The system may as well check pressure, location, moisture, and identifying additional fire events near the fire extinguisher, and dialing by providing the location to the rescue forces.

There can be in different means of transport. According to the present invention, the invention is also suitable for buses, trucks or any land or sea means of transport, including air.

According to another preferred configuration, weight can also be checked by a weight sensor in addition to the other additional measurements.

Further to reading the pressure by electricity conducting pin 42B, a camera may capture the position of hand 48, the capture for being processed to pressure reading, thus for converting for converting pressure measurement of fire extinguisher 12 to electronic information. An additional camera will ensure that fire extinguisher is accessible, and warn otherwise.

Thus, in one aspect, the invention is directed to a pressure information reporting apparatus (10) for being assembled to a fire extinguisher (12), the pressure information reporting apparatus (10) including:
a convertor (56B), for converting pressure measurement of the fire extinguisher (12) to electronic information; and
a transmitter (56A), for transmitting the electronic information.

The convertor (56B) may be for converting the position of the hand (48) of the mechanical pressure meter (18) to electronic information.

The convertor (56B) may include:
a first electricity conducting pin (42B), for attaching a hinge (42A) of a hand (48) of a mechanical pressure meter (18);
a second electricity conducting pin (44B), for attaching a blocker (44A) of the hand (48) of the mechanical pressure meter (18); and
wiring (42C, 44B) extending from the pins (42B, 44B) to the transmitter (56A).

The convertor (56B) may further include:
a transparent plate (40B), including niches (42D, 44D) for holding the electricity conducting pins (42B, 42D).

The convertor (56B) may include:
a micro-switch (60) disposed near a hand (48) of a mechanical pressure meter (18), for being pressed by the hand (48) once the hand (48) indicates low pressure; and
wiring (42C, 44B) extending from the pins (42B, 44B) to the transmitter (56A).

The transmitter (56A) may further be for transmitting location of the fire extinguisher (12).

The fire extinguisher (12) may be located on ground, building, ship, airplane, vehicle.

In the figures and description herein, the following reference numbers (Reference Signs List) have been mentioned:
number 10 denotes the information reporting apparatus according to one embodiment of the invention;
12: prior art fire extinguisher;
18: prior art mechanical pressure meter;
22: smartphone;
24: location;
26: map;
28: instructions to arrive the location;
32: sensor;
40A: transparent plate of prior art mechanical pressure meter 18;
40B: transparent plate of information reporting apparatus 10;
42A: hinge of hand 48 of mechanical pressure meter 18;
42B: electricity conducting pin of information reporting apparatus 10;
42C: electric wire;
42D: niche of transparent plate 40B;
44A: block of hand 48 of mechanical pressure meter 18;
44B: electricity conducting pin of information reporting apparatus 10;
44C: electric wire;
44D: niche of transparent plate 40B;
50A: mechanical unit;
50B: electronic unit;
56A: transmitter;
56B: convertor;
57: extension of pin 44B;
58: battery;
60: micro-switch;
62: arm of micro-switch 60;
70: user's eye viewing hand 48 through transparent plate 40B.

The foregoing description and illustrations of the embodiments of the invention have been presented for the purpose of illustration, and are not intended to be exhaustive or to limit the invention to the above description in any form.

Any term that has been defined above and used in the claims, should be interpreted according to this definition.

The reference numbers in the claims are not a part of the claims, but rather used for facilitating the reading thereof. These reference numbers should not be interpreted as limiting the claims in any form.

What is claimed is:

1. A pressure information reporting apparatus for being assembled to a fire extinguisher, said pressure information reporting apparatus comprising:
a convertor, for converting pressure measurement of said fire extinguisher to electronic information; and
a transmitter, for transmitting said electronic information.

2. The pressure information reporting apparatus according to claim 1, wherein said convertor comprises a convertor for converting a position of a hand of a mechanical pressure meter to said electronic information.

3. The pressure information reporting apparatus according to claim 1, wherein said convertor comprises:
a first electricity conducting pin, for attaching a hinge of a hand of a mechanical pressure meter;
a second electricity conducting pin, for attaching a blocker of said hand of said mechanical pressure meter; and
wiring extending from said pins to said transmitter.

4. The pressure information reporting apparatus according to claim 3, wherein said convertor further comprises:
a transparent plate, comprising niches for holding said electricity conducting pins.

5. The pressure information reporting apparatus according to claim 1, wherein said convertor comprises:
a micro-switch disposed near a hand of a mechanical pressure meter, for being pressed by said hand once said hand indicates low pressure; and
wiring extending from said pins to said transmitter.

6. The pressure information reporting apparatus according to claim 1, wherein said transmitter is further for transmitting location of said fire extinguisher.

7. The pressure information reporting apparatus according to claim 1, wherein said fire extinguisher is located on a member selected from a group consisting of: ground, building, ship, airplane, vehicle.

8. The pressure information reporting apparatus according to claim 1, for further informing weight, location, moisture, additional fire events near the fire extinguisher, and dialing by providing the location to the rescue forces.
